(19) United States
(12) Patent Application Publication
(10) Pub. No.: US 2013/0167089 A1
(43) Pub. Date: Jun. 27, 2013

(54) ELECTRONIC DEVICE

(71) Applicant: PANASONIC CORPORATION, Osaka (JP)

(72) Inventor: MITSUO ABE, Osaka (JP)

(73) Assignee: PANASONIC CORPORATION, Osaka (JP)

(21) Appl. No.: 13/713,125

(22) Filed: Dec. 13, 2012

(30) Foreign Application Priority Data
Dec. 21, 2011 (JP) 2011-279431
Jul. 24, 2012 (JP) 2012-164128

(51) Int. Cl. G06F 3/0481

(52) U.S. Cl. CPC G06F 3/04817
USPC 715/835

(57) ABSTRACT

The touch panel superposed over a display component outputs a operation signal upon receiving an input operation. A controller displays icons on the display component. The controller also detects the selection of the icons based on the operation signal. The controller displays menu category icons indicating menu categories, on the display component. The controller displays setting icons indicating setting categories included in the selected menu category, on the display component according to the detection of the selection of the menu category icon. The controller displays first information related to the selected menu category, on the display component according to the detection of the selection of the menu category icon. The controller displays second information related to the selected setting category, on the display component according to the detection of the selection of the setting icon.

### CROSS-REFERENCE TO RELATED APPLICATIONS

This application claims priority under 35 U.S.C. §119 to Japanese Patent Application No. 2011-279431, filed on Dec. 21, 2011 and No. 2012-164128, filed on Jul. 24, 2012. The entire disclosure of Japanese Patent Application No. 2011-279431 and No. 2012-164128 are hereby incorporated herein by reference.

### BACKGROUND

1. Technical Field

The technology disclosed herein relates to an electronic device which performs settings by having the user select from a menu display.

2. Background Information

With digital cameras and other such electronic devices, a menu is displayed on a monitor to adjust the settings of the device, and the user selects the desired menu categories and setting values on this menu screen. With an electronic device such as this, an explanation related to the displayed menu categories is displayed (see Japanese Laid-Open Patent Application 2007-274381, for example).

With this conventional electronic device, an explanation related to the menu category to be selected on the menu screen is displayed on the same screen. The user operates buttons while looking at this explanation. For example, the user presses an enter button upon selecting the desired menu category. Consequently, even though the user may not yet understand the contents of the various menu categories, the user can select the menu categories while referring to the displayed explanation.

A problem with the configuration of the explanation displayed in the above-mentioned conventional electronic device was that it could not be directly applied when button operation was switched to touch panel operation. This problem will now be described.

With a conventional electronic device, first the user operates a button to select the desired menu category. The enter button is then operated to change the screen to a setting screen for that menu category. The user makes various setting adjustments on this setting screen. Therefore, with a conventional electronic device, it was possible to display an explanation about a menu category at the stage when the menu category was selected (the stage when the enter button had not yet been pressed).

When this button operation is switched to touch panel operation, it is possible to use an interface such as one with which the menu category is first selected by touch operation, and then the enter icon is touched on the screen. However, with this configuration, even though the touch panel has an interface characterized by intuitive operation, two touch operations are necessary to select the menu category. If the user does not fully understand the content of the menu category, the user will operate the touch panel while reading the explanation, so there is no problem with this configuration. However, if the user already understands the content of the menu category, two touch operations will be necessary with this configuration, so a problem is that this operation seems complicated to the user.

Meanwhile, with a configuration in which the user changes the screen to a menu category setting screen merely by touching a menu category, an explanation about the menu category cannot be displayed. In this case, it is possible to use a configuration in which an explanation icon for displaying an explanation of a menu category is displayed on the screen. With this configuration, when the user touches this explanation icon, an explanation about the touched menu category can be displayed. In this case, however, two touch operations are necessary when the user performs the display of the explanation, making the operation more complicated. Another problem is that a user may have difficulty figuring out how to use the explanation icon.

The present technique was conceived in light of the above problems, and provides an electronic device with which settings can be performed smoothly by touch panel operation.

### SUMMARY

The electronic device disclosed herein includes a display component, a touch panel, and a controller. The display component is configured to output a display screen. The touch panel is superposed over the display component and configured to output an operation signal upon receiving an input selection operation. The controller is configured to control a displaying of icons, including at least one of text and an image, on the display component and detect a selection of the icons based on the operation signal output by the touch panel. The controller is configured to display menu category icons indicating menu categories, on the display component. The controller is configured to display setting icons indicating setting categories included in a selected menu category on the display component, and display first information related to a selected menu category, on the display component, according to a detection of the selection of the menu category icon. The controller is configured to display second information related to a selected setting category, on the display component, according to a detection of the selection of the setting icon.

With this technique, it is possible to provide an electronic device with which settings can be performed smoothly by touch panel operation.

### BRIEF DESCRIPTION OF THE DRAWINGS

Referring now to the attached drawings, which form a part of this original disclosure:

FIG. 1 is a front view of a digital camera pertaining to an embodiment;

FIG. 2 is a rear view of the digital camera pertaining to this embodiment;

FIG. 3 is a block diagram of the digital camera pertaining to this embodiment;

FIG. 4 is a flowchart showing the flow of processing in imaging mode by the digital camera pertaining to this embodiment;

FIG. 5 is a state transition diagram in setting processing by the digital pertaining to this embodiment; and

FIG. 6 is a diagram showing an example of the screen display at various levels of the menu.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the embodiments as defined by the appended claims and their equivalents. It should also be apparent that the following described embodiments are not exhaustive of all the envisioned embodiments that are possible.

Next, embodiments of this technique will be described through reference to the drawings. In the description of the drawings, those portions that are the same or similar will be given the same or similar numbers. These drawings are merely schematic representations, however, and the dimensional proportions and so forth may differ from those of the actual components. Moreover, there are also portions in which the dimensional relation and proportions differ from one drawing to the next.

In the following embodiments, a digital camera will be described as an example of an imaging device. In the following description, using a digital camera in its normal orientation (hereinafter also referred to as the landscape orientation) as a reference, the direction facing the subject will be called “forward,” a direction away from the subject will be called “rearward,” vertically upward will be called “upward,” vertically downward will be called “downward,” to the right in a state of directly facing the subject will be called “to the right,” and to the left in a state of directly facing the subject will be called “to the left.”

### First Embodiment

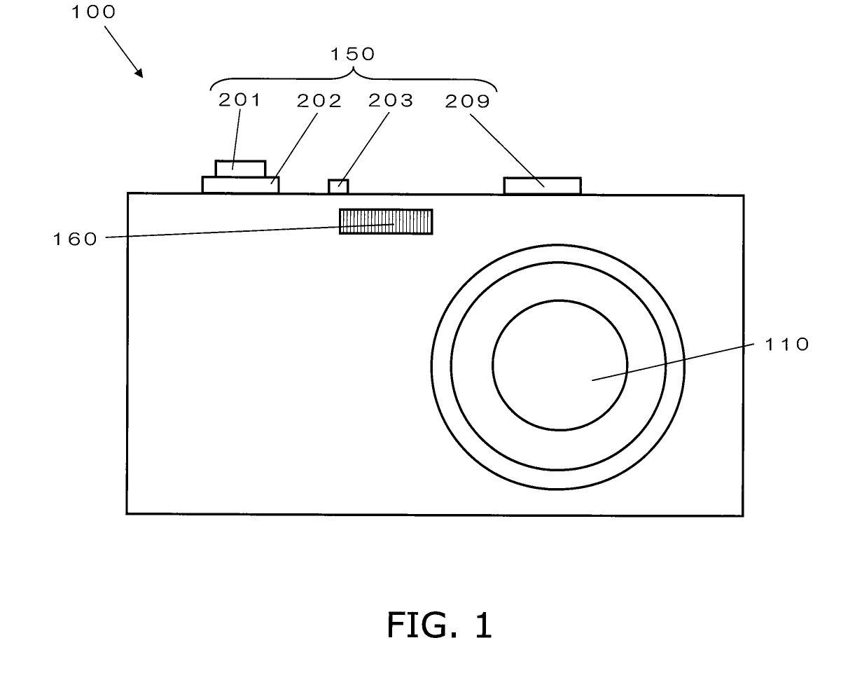

The digital camera 100 (an example of an imaging device) pertaining to an embodiment will now be described through reference to FIGS. 1 to 4. The digital camera 100 is an imaging device capable of capturing both moving and still pictures.

### 1. Configuration of Digital Camera

FIG. 1 is a front view of a digital camera pertaining to an embodiment. As shown in FIG. 1, the digital camera 100 comprises on its front face a lens barrel that houses an optical system 110, and a flash 160. The digital camera 100 comprises on its upper face an operation unit 150 including a still picture release button 201, a zoom lever 202, a power button 203, a scene switching dial 209, and so forth.

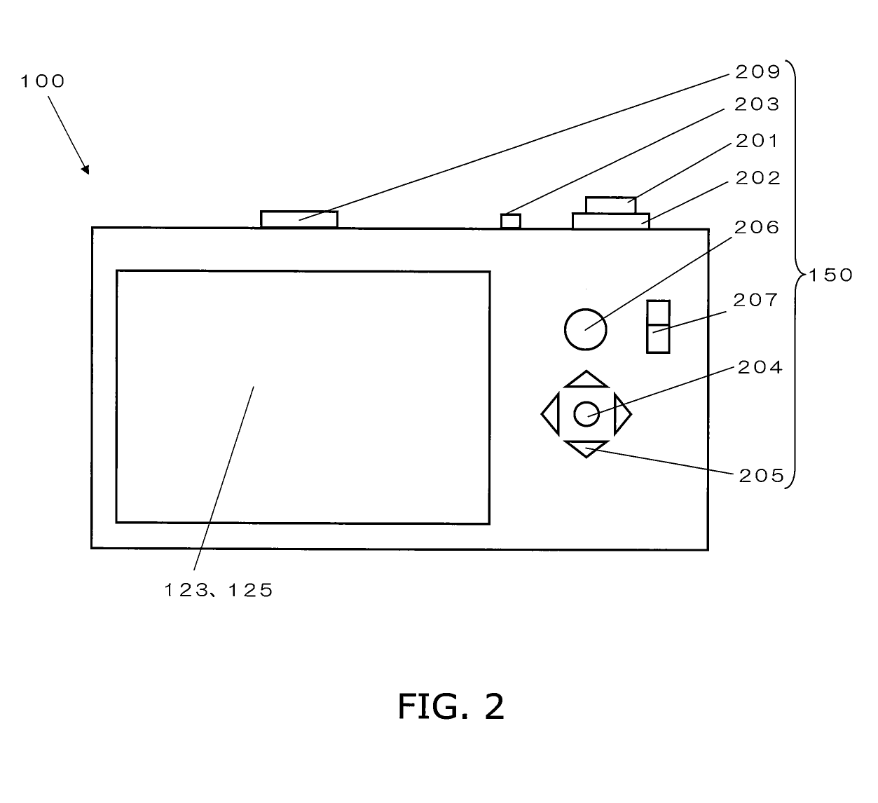

FIG. 2 is a rear view of the digital camera pertaining to this embodiment. As shown in FIG. 2, the digital camera 100 comprises on its rear face a liquid crystal monitor 123, a touch panel 125, and the operation unit 150. The operation unit 150 includes a center button 204, directional buttons 205, a moving picture release button 206, a mode switch 207, and so forth.

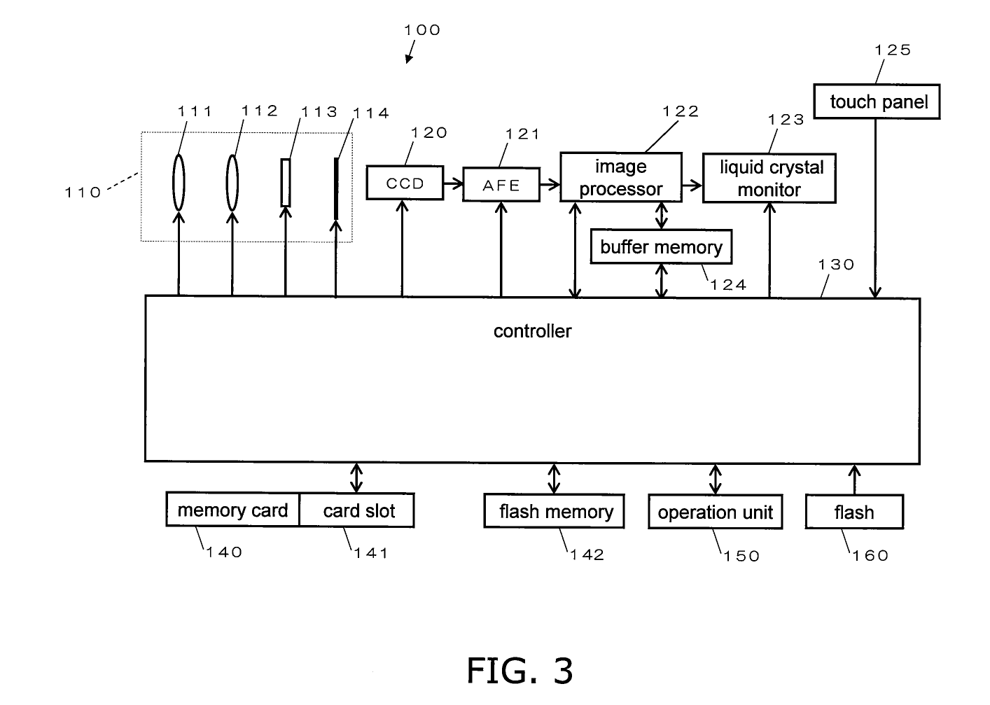

FIG. 3 is a block diagram of the digital camera pertaining to this embodiment. As shown in FIG. 3, the digital camera 100 comprises the optical system 110, a CCD image sensor 120, an AFE (analog front end) 121, an image processor 122, a buffer memory 124, the liquid crystal monitor 123, the touch panel 125, a controller 130, a card slot 141, a memory card 140, a flash memory 142, the operation unit 150, and the flash 160.

The optical system 110 forms a subject image. The optical system 110 has a focus lens 111, a zoom lens 112, an aperture 113, and a shutter 114. As another embodiment, the optical system 110 may include an optical image stabilizer OIS. The lens included in the optical system 110 may consist of any number of lenses, or may consist of any number of lens groups.

The focus lens 111 is used to adjust the focal state of the subject. The zoom lens 112 is used to adjust the field angle of the subject. The aperture 113 is used to adjust the amount of light incident on the CCD image sensor 120. The shutter 114 adjusts the exposure time of light incident on the CCD image sensor 120. The focus lens 111, the zoom lens 112, the aperture 113, and the shutter 114 are each driven by a DC motor, stepping motor, or other such drive unit, according to a control signal sent from the controller 130.

The CCD image sensor 120 is an imaging element that captures a subject image formed by the optical system 110. The CCD image sensor 120 produces image data for each frame of the subject image.

The AFE (analog front end) 121 subjects the image data produced by the CCD image sensor 120 to various kinds of processing. More specifically, the AFE 121 performs noise suppression by correlated double sampling, amplification to the input range width of an A/D converter by an analog gain controller, A/D conversion by an A/D converter, and the like.

The image processor 122 performs various kinds of processing on the image data that has undergone processing by the AFE 121. The image processor 122 subjects the image data to smear correction, white balance correction, gamma correction, YC conversion processing, electronic zooming, compression processing, reduction processing, expansion processing, and other sorts of processing. By subject the image data to this processing, the image processor 122 produces through-images and recorded images. In this embodiment, the image processor 122 is a microprocessor that executes programs. However, in another embodiment, the image processor 122 may be a hard-wired electronic circuit. The image processor 122 may also be configured integrally with the controller 130, etc.

The controller 130 performs overall control over the operation of the entire digital camera 100. The controller 130 consists, for example, of a ROM and a CPU. The ROM holds programs for overall control of the entire digital camera 100, as well as programs for file control, auto-focus control (AF control), auto-exposure control (AE control), and emission control of the flash 160.

The controller 130 records image data that has undergone various processing by the image processor 122, as still picture data or moving picture data, to the memory card 140 and the flash memory 142 (hereinafter referred to as the “memory card 140, etc.”). In this embodiment, the controller 130 is a microprocessor that executes programs. In another embodiment, the controller 130 may be a hard-wired electronic circuit. The controller 130 may also be configured integrally with the image processor 122, etc.

The liquid crystal monitor 123 displays through-images, recorded images, and other such images. The through-images and recorded images are produced by the image processor 122. A through-image is a series of images produced continuously at specific time intervals while the digital camera 100 is set to imaging mode. More precisely, a series of image data corresponding to a series of images is produced by the CCD image sensor 120 at specific time intervals. The user takes a photograph while checking the composition of the subject by referring to the through-image displayed on the liquid crystal monitor 123.

A recorded image is an image obtained by decoding (expanding) still picture data or moving picture data recorded to the memory card 140, etc. A recorded image is displayed on the liquid crystal monitor 123 when the digital camera 100 is set to reproduction mode. In another embodiment, any display capable of displaying images, such as an organic EL display, may be used instead of the liquid crystal monitor 123.

The touch panel 125 is an operation interface that is operated by the user in conjunction with the liquid crystal monitor 123. The touch panel 125 is disposed so that it is superposed with the liquid crystal monitor 123. The controller 130 detects the coordinates of the area selected with an indicating object (such area hereinafter referred to as the touch area). More specifically, the touch area is the area on the touch panel 125 that is touched by the user. The term “indicating means” here refers to the user's finger, a stylus, or the like.

The controller 130 determines an object, such as an icon displayed in an area on the liquid crystal monitor 123, corresponding the touch area on the touch panel 125. The controller 130 also executes specific processing corresponding to selection of this object. The user can touch an icon to display various menu screens on the liquid crystal monitor 123 and perform settings on the digital camera 100.

The buffer memory 124 is a volatile recording medium that functions as a working memory for the controller 130 and the image processor 122. In this embodiment, the buffer memory 124 is a DRAM.

The flash memory 142 functions as an internal memory of the digital camera 100. The flash memory 142 is a nonvolatile recording medium. The flash memory 142 has a customized category registration area and a current value holding area (not shown).

The memory card 140 can be removably inserted into the card slot 141. The card slot 141 is electrically and mechanically connected to the memory card 140.

The memory card 140 is an external memory of the digital camera 100. The memory card 140 is a nonvolatile recording medium.

The operation unit 150 is an operation interface that is operated by the user. The operation unit 150 is the collective name for buttons, dials, and the like disposed on the outside of the digital camera 100. The operation unit 150 includes the still picture release button 201, the moving picture release button 206, the zoom lever 202, the power button 203, the center button 204, the directional buttons 205, and the mode switch 207. When operated by the user, the operation unit 150 immediately sends the controller 130 a signal corresponding to the content of the operation.

The still picture release button 201 is a push switch for indicating the timing of still picture recording. The moving picture release button 206 is a push switch for indicating the timing of starting and ending moving picture recording. The controller 130 directs the image processor 122, etc., to produce still picture data or moving picture data to match the timing at which the release button 201 or 206 was pressed, and stores this data on the memory card 140.

The zoom lever 202 is used to adjust the field angle between the wide angle end and the telephoto end. The controller 130 drives the zoom lens 112 according to how the zoom lever 202 is operated by the user.

The power button 203 is a slide switch for switching the power supply on and off to the various components of the digital camera 100.

The center button 204 and the directional buttons 205 are push switches. The user can operate either the center button 204 or the directional buttons 205 to display various menus screens on the liquid crystal monitor 123 and perform settings of the digital camera 100. On these menu screens, the desired setting values can be set for the various categories of the menu related to various imaging conditions and reproduction conditions.

The mode switch 207 is a push switch for switching the digital camera 100 between imaging mode and reproduction mode.

The scene switching dial 209 is used to switch the scene mode. “Scene mode” is the collective name for the mode set according to the imaging situation. Factors that affect the imaging situation include the subject, the imaging environment, and so on. One of several scene modes is set by turning the scene switching dial 209.

Scene modes include, for example, landscape mode, portrait mode, nighttime mode, nighttime mode that corrects for hand shake, reverse lighting mode, automatic scene determination mode, and so on. For example, portrait mode is suited to imaging so that the skin tone of a person has the proper hue. The nighttime mode that corrects for hand shake (handheld nighttime mode) is suited to imaging in a state of little ambient light (in a low lighting environment) without the use of a tripod or other such fixing device for the digital camera 100. The reverse lighting mode is suited to when the image is captured in an environment with a large contrast.

When the automatic scene determination mode is selected, one mode is automatically set from among landscape mode, portrait mode, nighttime mode, handheld nighttime mode, and reverse lighting mode, for example, based on the image data.

### 2. Operation in Imaging Mode

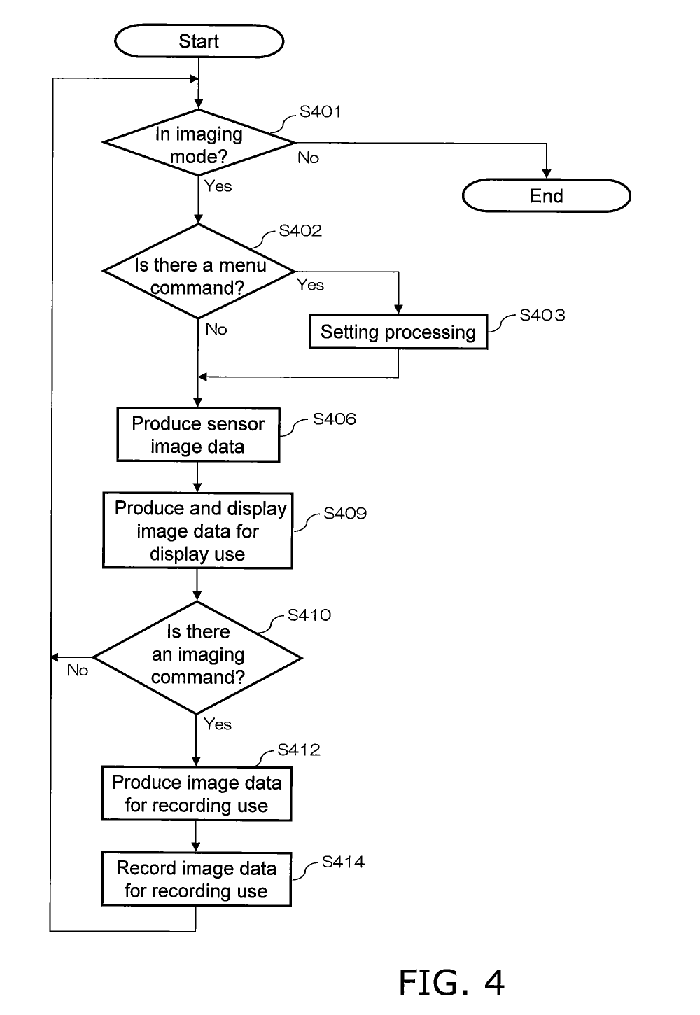

FIG. 4 is a flowchart of the flow of processing in imaging mode with the digital camera pertaining to this embodiment. The operation in imaging mode will now be described through reference to FIG. 4.

When the power button 203 is operated and power is turned on to the digital camera 100, the controller 130 refers to the setting on the mode switch 207 (S401). More precisely, the controller 130 determines whether the setting on the mode switch 207 is imaging mode or reproduction mode. If the mode switch 207 has been set to reproduction mode (No in S401), the controller 130 ends processing related to imaging mode.

If the mode switch 207 has been set to imaging mode (Yes in S401), the controller 130 then detects whether or not the user has operated the touch panel 125 to indicate menu display for setting (S402). More specifically, when the user performs a specific operation, such as touching a menu icon on the touch panel 125, the controller 130 detects this operation to the touch panel 125. If the controller 130 detects indication of a menu display (Yes in S402), menu display is performed and the flow moves on to setting processing (S403). This setting processing will be described in greater detail below. Upon completion of the setting processing, the flow moves to step S406. If no indicating for menu display is detected (No in S402), the flow moves to step S406.

The controller 130 recognizes the image data produced by the CCD image sensor 120 (sensor image data) (S406). Then, the image processor 122 performs YC conversion processing, expansion or reduction processing, or other specific processing on the sensor image data to produce image data for display. A through-image is then displayed on the liquid crystal monitor 123 based on this display-use image data (S409).

The controller 130 at this point determines whether or not the user has pressed the still picture release button 201 (S410). If the still picture release button 201 has not been pressed (No in S410), the flow returns to step S401. If the still picture release button 201 has been pressed (Yes in S410), the controller 130 performs the following imaging operation.

The controller 130 controls the CCD image sensor 120 to produce recording-use image data. The image processor 122 performs YC conversion processing, expansion or reduction processing, encoding processing, or such other processing on the image data thus produced (S412). When this recording-use image data is produced, the controller 130 subjects the data to processing for recording the data to a recording component, such as the memory card 140 (S414). After this, the controller 130 again performs processing for referring to the mode (imaging mode or reproduction mode) set with the mode switch 207 (S401). The above series of operations is repeated until the user either turns off the power or changes the mode switch 207 to reproduction mode.

### 3. Operation in Menu Setting

The operation for setting the digital camera 100 when the user has directed menu display will now be described.

The digital camera 100 in this embodiment has an information display function on the setting menu. The information display function is a function for displaying an explanation of menu categories or setting values. In information display, this function changes the display content at each level of the menu. At the lowest level of the menu, this function changes the display content according to whether or not a specific amount of time has elapsed since the setting value was selected. Menu display, setting processing, and the information display function will now be described in detail.

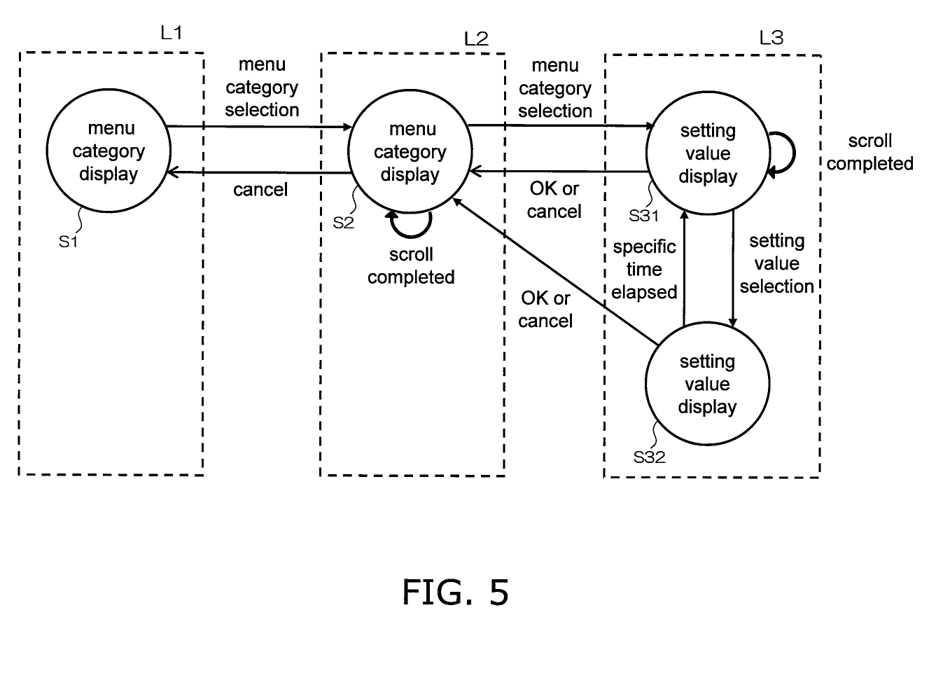

FIG. 5 is a state transition diagram of setting processing in the digital camera 100. In FIG. 5, the levels are called L1, L2, and L3, starting from the highest menu level. In the setting menu of the digital camera 100 in this embodiment, when a menu category is selected, the level moves from L1 to L2. When the menu category is selected on the level L2, the setting values of the menu category is selected on the level L3. The internal state of the digital camera 100 corresponding to level L1 shall be termed state S1, the internal state corresponding to level L2 shall be termed state S2, and the internal state corresponding to level L3 shall be termed state S31 and state S32.

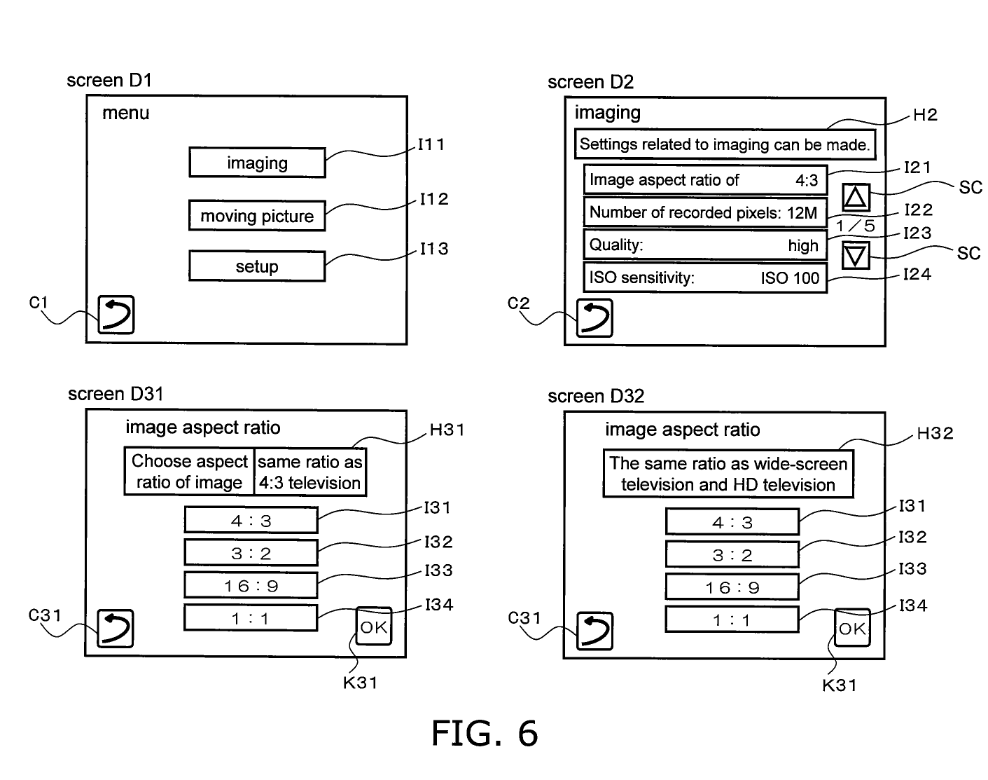

FIG. 6 is a diagram showing an example of the screen display at various levels of the menu. The screen corresponding to level L1 and state S1 is screen D1, the screen corresponding to level L2 and state S2 is screen D2, and the screen corresponding to level L3 is screen D31 and screen D32. The state S31 corresponds to the screen D31, and the state S32 corresponds to the screen D32. The screens D1 and D2 are used to select menu categories, while the screens D31 and D32 are used to select setting values for the menu category selected on the screen D2. The screen D1 displays menu categories in which categories that can be set in the digital camera 100 are grouped by function, as selection branches. The screen D2 displays categories included in the menu category selected on the screen D1, as selection branches. The screens D31 and D32 display setting values that can be selected in the menu category selected on the screen D2, as selection branches.

When the user performs a specific operation, such as touching a menu icon on the touch panel 125, the controller 130 detects the operation of the touch panel 125 and changes to state S1 of level L1, which is the initial state in setting processing.

(1) Level L1

In the state S1, the controller 130 displays the screen D1 shown in FIG. 6 on the liquid crystal monitor 123. The screen D1 includes “imaging”, “moving picture”, “setup”, and so forth as menu categories of the digital camera 100. For example, in “imaging” setting related to the conditions for capturing a still picture with the digital camera 100 is performed, and in “moving picture” setting related to the conditions for capturing a moving picture is performed. The menu categories included in “setup” include clock setting and the like, for example.

On the screen D1, the controller 130 displays icons I11, I12, and I13 as icons indicating menu categories. I11 corresponds to the menu category of “imaging” and I12 corresponds to the menu category of “moving picture”. I13 corresponds to “setup”. The controller 130 also displays an icon C1 corresponding to operation for ending menu setting.

If the user operates the touch panel 125 in the state S1, the controller 130 performs operation corresponding to the icon touched by the user. Upon detecting that the user has touched the icon I11, the controller 130 changes the state to state S2 of level L2, which is the next lowest level. Similarly, upon detecting that the user has touched the icon I12 or I13, the controller 130 changes the state to a state (not shown) corresponding to the respective icon, although this will not be described in detail herein. When the user touches the icon C1, the controller 130 ends the setting processing operation.

(2) Level L2

In the state S2, the controller 130 displays the screen D2 shown in FIG. 6 on the liquid crystal monitor 123. The screen D2 displays the menu categories included in “imaging” which is a menu category on the screen D1. Menu categories for “imaging” on the digital camera 100 include “image aspect ratio”, “number of recorded pixels”, “quality”, “ISO sensitivity”, “white balance”, “flash”, “aperture”, “shutter speed”, “exposure correction”, “auto bracket”, “focus mode”, and so forth. The icon indicating these menu categories is an example of “menu category icon”.

On the screen D2, the controller 130 displays icons I21, I22, I23, I24, and C2 as icons indicating some of these menu categories. The icon I21 corresponds to the menu category of “image aspect ratio”, while the icon I22 corresponds to the menu category of “number of recorded pixels”. The icon I23 corresponds to the menu category of “quality”, while the icon I24 corresponds to the menu category of “ISO sensitivity”. It is also possible to display icons corresponding to other menu categories by touching a scroll icon SC. The icon C2 corresponds to an operation for changing from the state S2 to the state S1.

Also, the controller 130 displays explanatory text related to the “imaging” selected in state S1 belonging to the next highest level L1, in a display area H2 of the screen D2 in state S2 belonging to level L2. Explanatory text about the menu categories corresponding to the icon touched by the user in state S1 (the icon I11 in this case) is displayed in the display area H2. For example, explanatory text of “settings related to imaging can be made” is displayed on the screen D2. More specifically, explanatory text corresponding to the selected icon I11 is acquired from the flash memory 142 and displayed in the display area H2.

More specifically, when the controller 130 displays explanatory text, it checks whether the number of characters is greater than or less than the number that can be displayed at one time in the display area H2. If the number of characters of explanatory text is less, the entire explanatory text is always displayed in the display area H2, but if the number of characters is greater than the number that can be displayed in the display area H2, the controller 130 performs an operation that will display all of the characters by scrolling through the explanatory text in the display area H2. Even when the user has scrolled all the way through the explanatory text, during the state S2 the controller 130 performs the operation of displaying the explanatory text by repeated scrolling.

If the user operates the touch panel 125 in the state S2, the controller 130 performs an operation corresponding to the icon touched by the user. Upon detecting that the user has touched the icon I21, the controller 130 changes the state to the state S31 of the next lowest level L3. Similarly, upon detecting that the user has touched the icon I22, I23, or I24, the controller 130 changes the state to the state (not shown) corresponding to the respective icon, but this will not be described in detail here. If the user touches the icon C2, the controller 130 changes the state from S2 to S1 of the next highest level L1.

(3) Level L3

When the state changes from S2 to S31, the controller 130 displays on the liquid crystal monitor 123 the screen D31, which is the screen corresponding to the menu category (the icon I21 in this case) touched by the user on S2. The screen D31 includes “4:3”, “3:2”, “16:9”, and “1:1”, as selection branches for the setting values corresponding to the menu category “aspect ratio” of the digital camera 100. The icons indicating these setting values are an example of “setting icons”.

On the screen D31, the controller 130 displays I31, I32, I33, and I34 as icons indicating setting values. I31 corresponds to “4:3”, 132 corresponds to “3:2”, I33 corresponds to “16:9”, and I34 corresponds to “1:1”. Here, the controller 130 displays the icon corresponding to the current setting value for “image aspect ratio” so that it can be distinguished from other icons. More specifically, the controller 130 acquires the current setting value of the menu category I21 from the flash memory 142, and displays in highlight the icon I31 corresponding to “4:3”, which is the current setting value (the highlighted display is not shown). The controller 130 also displays an icon C31 and an icon K31. The selection of the icon C31 executes an operation of canceling the change to the setting value at level L3 and changing the state from S31 to S2. The selection of the icon K31 executes a enter operation on D31. The enter operation on the screen D31 is an operation of performing processing to update the setting value of the currently selected menu category to the setting value selected by the user, and then changing to the state S2 of the next highest level L2.

The screen D31 is used to select setting values for menu categories. The controller 130 executes processing for displaying explanatory text about the menu category I21 (an example of first information) selected in state S2 belonging to the next highest level L2, in a display area H31. The controller 130 also executes processing for displaying explanatory text about the current setting value of the menu category I21, in the display area H31. More specifically, the controller 130 acquires the current setting value for the menu category I21 from the flash memory 142, and then acquires explanatory text corresponding to the menu category I21 and explanatory text corresponding to the current setting value from the flash memory 142. The controller 130 links up explanatory text about the menu category I21 and explanatory text about the current setting value in that order, and displays the result in the display area H31. For example, if “4:3” is the current setting value for the “image aspect ratio”, then explanatory text of “choose aspect ratio of image” and explanatory text of “same ratio as 4:3 television or personal computer screen” for the “image aspect ratio” are linked in that order, and the result is displayed as “choose aspect ratio of image/same ratio as 4:3 television or personal computer screen”. The controller 130 checks whether the number of characters of the linked explanatory text is greater than or less than the number of characters that can be displayed, just as with the screen D2, and determines whether to use a scroll display.

If the user operates the touch panel 125 in the state S31, the controller 130 performs an operation corresponding to the icon touched by the user. If the touched icon is either I31, I32, I33, or I34, the controller 130 changes the state to the state S32 of the same level L3. If the touched icon is the icon C31, the controller 130 changes the state to the state S2 of the next highest level L2 from the state S31. If the touched icon is the icon K31, the controller 130 performs the above-mentioned enter operation.

When the state changes from S31 to S32, the controller 130 uses the setting value (“16:9” in this case) corresponding to the icon touched by the user (the icon I33 in this case) as the current setting value of the menu category (the “image aspect ratio” in this case). The controller 130 also displays the screen D32, which is a screen corresponding to the icon touched by the user in the state S31 (the icon I33), on the liquid crystal monitor 123. On the screen D32, the icon touched by the user in the state S31 (the icon I33) is displayed in highlight (the highlighted display is not shown).

The icons displayed on the screen D32 are nearly the same as those on the screen D31, but explanatory text corresponding to the icons I31, I32, I33, and I34 touched on the screen D31 (an example of second information) is displayed as the explanatory text displayed in a display area H32. More specifically, the controller 130 acquires explanatory text corresponding to the setting value corresponding to the icon touched by the user in the state S31, from the flash memory 142. The controller 130 displays this explanatory text in the display area H32. If the user touches the icon I33, the explanatory text “the same ratio as wide-screen television and HD television” corresponding to the icon I33 is displayed. The controller 130 checks whether the number of characters of the explanatory text is greater than or less than the number of characters that can be displayed in the display area H32, just as with the screen D2, and determines whether to use a scroll display.

Once a certain amount of time has elapsed since the controller 130 displayed the explanatory text about the touched icon, the state changes to S31. At this point, since “16:9” is the current setting value for the “image aspect ratio”, the controller 130 links up the explanatory text of “choose aspect ratio of image” and the explanatory text of “same ratio as wide-screen television and HD television” for the “image aspect ratio” in that order, and the result is displayed as “choose aspect ratio of image/same ratio as wide-screen television and HD television”.

Thus, with the digital camera 100 of this embodiment, in the initial state after a change to the level L3 of the menu, or in the state S31 that is a state after a certain amount of time has elapsed since the user selected the setting value, explanatory text about the menu category I21 and the current setting value are linked and displayed together. Therefore, the user can check whether or not the selected menu category is the desired menu category by reading the explanatory text related to the selected menu category. Also, since explanatory text about the current setting value can also be read at this point, the current setting value can also be confirmed.

Meanwhile, in the state S32, which is the state immediately after the user selects the setting value (within a specific length of time since the selection), explanatory text related to the selected setting value can be obtained by displaying just the explanatory text about the setting value touched by the user. Therefore, if the user wishes to know a plurality of setting values displayed as selection branches in the level L3 of the menu, that icon is touched so that the setting value thereof is tentatively selected. Also, at this point the user can read the explanatory text related to this setting value right away. For example, when the user touches the icon for “16:9” in the display area D31, the state changes to the state S32 and the explanatory text of “the same ratio as wide-screen television and HD television” for “16:9” is displayed in the display area H32 (screen D32). When the display of explanatory text in the display area H32 is over, the state is switched to the state S31. Consequently, “choose aspect ratio of image/same ratio as wide-screen television and HD television” is displayed in the display area H31.

When the user touches the setting values in order, reads the explanatory text, and finds the desired setting value, the icon K31 is touched at that point. Consequently, the controller 130 performs an enter operation, and the setting value that was last selected is set as the setting value for the menu category.

### 4. Features

The digital camera 100 in this embodiment comprises the liquid crystal monitor 123, the touch panel 125, and the controller 130. The touch panel 125 is disposed superposed over the liquid crystal monitor 123. The touch panel 125 outputs an operation signal upon receipt of a user input operation. The controller 130 displays icons including characters and/or images on the liquid crystal monitor 123.

With the digital camera 100 thus configured, the controller 130 detects the selection of icons based on the operation signal. The controller 130 displays the menu category icons I21 to I24 indicating menu categories on the liquid crystal monitor 123. Upon detecting the selection of the menu category icons I21 to I24, the controller 130 displays the setting icons I31 to I34 included in the selected menu category on the liquid crystal monitor 123. Also, the controller 130 displays the explanatory text H31 (an example of first information) corresponding to the selected menu category icons I21 to I24 on the liquid crystal monitor 123. Upon detecting the selection of the setting icons I31 to I34, the controller 130 displays the explanatory text H32 related to the selected setting category (an example of second information) on a display component.

With this configuration, explanatory text about a menu category can be displayed immediately after the user has selected that menu category. Therefore, the user can confirm whether or not the selected menu category is the desired menu category by reading explanatory text related to the selected menu category. Also, explanatory text about the setting value touched by the user can be displayed immediately after the user has selected that setting value. Therefore, the user can confirm the selected setting value before actually selecting that setting value.

### Other Embodiments

An embodiment of the present technique was described above, but the present technique is not limited to or by the above embodiment, and various modifications are possible without departing from the gist of the technique. In particular, embodiments and modification examples given in this Specification can be suitably combined as needed.

The following embodiments are examples of other embodiments.

In the above embodiment, at the level L3 (the lowest level), the state was changed to S2 after an enter operation, specifically processing in which the setting value for the currently selected menu category was updated to the setting value selected by the user, was carried out by touching the icon K31. However, the following may be done instead. Instead of providing the icon K31 corresponding to the enter operation, the operation of the controller 130 when the icon C31 is touched is such that the state is changed to S2 after performing processing to update to the setting value selected by the user. In this case, the processing for updating the setting value may be performed when the user has touched the icon of the setting value. The following may also be done. When the controller 130 detects that the user has pressed the same icon indicating a setting value two times in a row, the enter operation may be performed at that setting value. As to the two touch operations in a row here, the enter operation may be performed at that setting value when a second touch operation is performed on the same icon within a certain length of time since the first touch operation was detected.

In the above embodiment, explanatory text related to the setting value corresponding to the icon for the touched setting value was displayed on the liquid crystal monitor 123 in response to detection that the user had touched the setting value icon. However, the following may be done instead. The controller 130 may change the state to S32 in response to detection that the user has touched the setting value icon in the state S31, first display explanatory text related to the setting value corresponding to the touched setting value icon on the liquid crystal monitor 123, and then display explanatory text related to the menu category corresponding to that setting value on the liquid crystal monitor 123.

In the above embodiment, setting processing in imaging mode was described as an example, but the present technique can be applied to setting by menu. For example, it can also be applied to setting processing in reproduction mode. Also, the electronic device may be something other than a digital camera, such as a video camera, a smart phone, or a computer.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the electronic device. Accordingly, these terms, as utilized to describe the present technology should be interpreted relative to the electronic device.

The term “configured” as used herein to describe a component, section, or part of a device implies the existence of other unclaimed or unmentioned components, sections, members or parts of the device to carry out a desired function.

The term “configured” as used herein to describe a component, section, or part of a device includes hardware and/or software that is constructed and/or programmed to carry out the desired function.

While only selected embodiments have been chosen to illustrate the present technology, it will be apparent to those skilled in the art from this disclosure that various changes and modifications can be made herein without departing from the scope of the technology as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further technologies by the applicant, including the structural and/or functional concepts embodied by such feature(s). Thus, the foregoing descriptions of the embodiments according to the present technologies are provided for illustration only, and not for the purpose of limiting the technology as defined by the appended claims and their equivalents.

### INDUSTRIAL APPLICABILITY

The present technique can provide an electronic device with which settings can be made smoothly by touch panel operation, and can therefore be provided to a digital still camera, digital video camera, portable telephone, smart phone, computer, or the like with which settings are made by menu.

What is claimed is:

1. An electronic device comprising:
a display component configured to output a display screen;
a touch panel superposed over the display component and configured to output an operation signal upon receiving an input selection operation; and
a controller configured to control a displaying of icons, including at least one of text and an image, on the display component and detect a selection of the icons based on the operation signal output by the touch panel, wherein the controller is configured to:
display menu category icons indicating menu categories on the display component;
display setting icons indicating setting categories included in a selected menu category on the display component, and display first information related to a selected menu category, on the display component, according to a detection of the selection of the menu category icon, and display second information related to a selected setting category, on the display component, according to a detection of the selection of the setting icon.

2. The electronic device according to claim 1, wherein:
the controller is configured to display the second information on the display component firstly, and display the first information on the display component secondly, according to the detection of the selection of the setting icon.

3. The electronic device according to claim 1, wherein:
the first information and the second information are displayed in a predetermined region of the display component.

4. The electronic device according to claim 1, wherein:
the controller is configured to display the first information on the display component firstly, and display third information corresponding to the current setting category secondly, on the display component, according to the detection of the selection of the menu category icon.

5. The electronic device according to claim 4, wherein:
the first information and the third information are displayed in a predetermined region of the display component.

6. The electronic device according to claim 1, wherein:
the controller is configured to hide the menu category icon on the display component, display the setting icon on the display component, and display the first information on the display component, according to the detection of the selection of the menu category icon.

7. An electronic device comprising:
a display component configured to output a display screen;
a touch panel superposed over the display component and configured to output an operation signal upon receiving a user input;
a controller configured to control the display component based upon the operation signal output by the tough panel, wherein the controller is operable to:
control the display component to output a menu display screen including a plurality of menu icons which are selectable by user input via the touch panel;
control the display component to output a setting display screen including a plurality of setting icons which correspond to a menu icon which is selected by the user input during output of the menu display screen, the plurality of setting icons being selectable by user input via the touch panel;
wherein the setting display screen includes explanatory information related to the menu icon which is selected by the user during output of the menu display screen.

8. The electronic device according to claim 7, wherein:
the controller is further operable to control the display component to output a second setting display screen which corresponds to a setting icon which is selected by user input during output of the setting display screen;
wherein the second setting display screen includes explanatory information related to the setting icon selected by the user during output of the setting display screen.

9. The electronic device according to claim 7, wherein the menu icons and setting icons include at least one of text and an image.

10. The electronic device according to claim 7, wherein the explanatory information related to the menu icon and the explanatory information related to the setting icon are displayed in a predetermined region of the display component.

11. The electronic device according to claim 7, wherein the explanatory information related to the menu icon and the explanatory information related to the setting icon are displayed as a scrolling text display.
